(19) United States
(12) Patent Application Publication
(10) Pub. No.: US 2008/0172940 A1
(43) Pub. Date: Jul. 24, 2008

(54) FLOWER AND PLANT PACKAGING CARTON BOX

(75) Inventors: Chao Chia Huang, Taichung Hsien (TW); Chin Chieh Huang, Taichung Hsien (TW)

Correspondence Address: KIRTON AND MCCONKIE, 60 EAST SOUTH TEMPLE,, SUITE 1800, SALT LAKE CITY, UT, 84111, US

(73) Assignee: AGRICULTURAL RESEARCH INSTITUTE, Taichung (TW)

(21) Appl. No.: 11/859,875

(22) Filed: Sep. 24, 2007

(30) Foreign Application Priority Data
Jan. 18, 2007 (TW) 096201014

(51) Int. Cl. A01G 9/02; B65D 5/00; B65D 85/52

(52) U.S. Cl. 47/84; 206/423; 229/120

(57) ABSTRACT

A packaging carton box for flower and plant transportation is disclosed. The flower and plant packaging carton box comprises a main body having a bottom surface, wherein the bottom surface comprises at least a first pore hole. While plural of the packaging carton boxes are piled up, an air flow channel is formed by the first pore holes at the bottom surfaces of the main bodies, so as to cooperate with the transport carrier having a cold air flow blowing from bottom to top. Therefore, the cold air flow may enter the interior of each of the main body of the packaging carton box through the first pore hole and the air flow channel for adjusting the interior temperature and humidity of the packaging carton box.

### FIELD OF THE INVENTION

The present invention relates to a packaging carton box, and more particularly to a packaging carton box for flower transportation.

### BACKGROUND OF THE INVENTION

Recently, the techniques of flower production and transportation are highly improved in Taiwan. The production of flowers not only suffices the domestic needs but also obtains reputation and wealth through exportation.

Generally speaking, flowers and plants are packed in packaging carton boxes and exported through marine container transportation based on cost consideration. However, it takes long delivery time shipping from Taiwan to Europe or America. If the storage condition or transportation process is improper, the quality of flowers and plants will be lowered, which may compromise the development of flower exportation.

Please refer to FIG. 1, which is a schematic diagram showing the structure of the conventional packaging carton box. As shown in FIG. 1, the pore holes 11 and/or 12 are disposed at laterals 101 of the main body 10 of the conventional carton box 1 for air circulation and the convenience of carrying. Nevertheless, the cold air flow of the refrigerated container for carrying the carton box 1 blows from the bottom to the top and thus the air flow may not directly enter the interior of the carton box 1 through the pore holes 11 and/or 12 at the laterals 101 of the main body 10. Besides, the carton boxes 1 are piled and packed tightly in the refrigerated container; hence the pore holes 11 and/or 12 at the laterals 101 of the main body 10 of conventional carton box 1 are usually being blocked owing to the displacement of carton boxes during transportation. The hindered air circulation increases temperature and humidity at the interior of the carton box 1. As a result, the damage rate of the flowers or plants will be raised, which seriously affects the exportation quality.

To enhance the air circulation of the carton boxes, the design of increasing the size of the pore hole at the laterals of the main body of carton box has been developed, but the increase of the pore hole size may reduce the structure intensity of the carton box. Besides, the improvement of air circulation thereby is not significant.

Therefore, it is required to develop a packaging carton box for enhancing the air circulation, so as to maintain the quality of flowers and plants during storage and transportation.

### SUMMARY OF THE INVENTION

The objective of the present invention is to provide a packaging carton box for flower and plant transportation. The pore hole is disposed at the bottom surface or at the bottom surface and the cover of the packaging carton box, so as to cooperate with the flowing direction of the cold air flow from the bottom to the top of the refrigerated container and promote the air circulation in the packaging carton box to prevent the damage of flowers and plants during transportation.

In addition, the air flow channel is formed at the joint of the pore holes at the bottom surface and the cover, wherein the pore holes are crisscross arranged or having different sizes. The carton box may also comprises plural pore holes disposed at the bottom and cover thereof. Since the pore holes at the bottom surface and the cover are easily aligned, the block of the air flow channel caused by the displacement of the adjoining packaging carton boxes during transportation can be avoided and poor air circulation can be prevented as well.

For achieving the foregoing purposes, a packaging carton box for flower and plant transportation is provided, so as to cooperate with the transport carrier with a cold air flow blowing from the bottom to the top. The packaging carton box comprises a main body having a bottom surface with at least a first pore hole, so as to form an air flow channel by the first pore hole of the main body for the cold air flow to enter the interior of each of the main body while piling plural of the packaging carton boxes.

In an embodiment, shape of the first pore hole is selected from the group consisting of rectangular, circle and oval-shape.

In an embodiment, the packaging carton box further comprises a cover covering the top of the main body, and the cover comprises at least a second pore hole.

In an embodiment, the first pore hole is corresponded to the second pore hole.

In an embodiment, the first pore hole and the second pore hole are crisscross arranged, so as to form the air flow channel at the joint of the first and second pore holes while plural of packaging carton boxes are piled up.

In an embodiment, the first pore hole and the second pore hole are aligned and overlapped, so as to form the air flow channel while plural of packaging carton boxes are piled up.

In an embodiment, the second pore hole is relatively larger than the first pore hole, so as to form the air flow channel at where the first and second pore holes overlapped while plural of packaging carton boxes are piled up.

In an embodiment, the first pore hole is relatively larger than the second pore hole so as to form the air flow channel at where the first and second pore holes overlapped while plural of packaging carton boxes are piled up.

In an embodiment, the flower packaging carton box further comprises an overlay for covering the packaging carton box or the first pore hole.

In an embodiment, the bottom surface comprises a plurality of first pore holes and the cover comprises a plurality of second pore holes so as to form said air flow channel at where the first pore hole and the second pore hole overlapped while plural of the packaging carton boxes are piled up.

### BRIEF DESCRIPTION OF THE DRAWINGS

FIG. 1 is a schematic diagram showing the structure of the conventional packaging carton box;

FIGS. 2(a) and 2(b) are schematic diagrams showing the upward and vertical views of packaging carton box of the first embodiment of the present invention, respectively;

FIG. 3 is a schematic diagram showing a pile of the packaging carton boxes of FIG. 2 stored within a container;

FIGS. 4(a) and 4(b) are schematic diagrams showing the upward and vertical views of packaging carton box of the second embodiment of the present invention, respectively;

FIG. 5 is a schematic diagram showing a pile of the packaging carton boxes of FIG. 4 stored within a container;

FIGS. 6(a) and 6(b) are schematic diagrams showing the upward and vertical views of packaging carton box of the third embodiment of the present invention, respectively;

FIG. 7 is a schematic diagram showing a pile of the packaging carton boxes of FIG. 6 stored within a container;

FIG. 8 is a schematic diagram showing the upward view of packaging carton box of the fourth embodiment of the present invention;

FIG. 9 is a schematic diagram showing a pile of the packaging carton boxes of FIG. 8;

FIG. 10 is a schematic diagram showing the upward view of the packaging carton box of the fifth embodiment of the present invention;

FIG. 11 is a schematic diagram showing the upward view of packaging carton box of the sixth embodiment of the present invention;

FIGS. 12(a) and 12(b) are the diagrams showing the temperature curve at the center of the packaging carton box of the control group (CK) and the experiment group (Trt. 2) beneath and above the leaves of the Phalaenopsis seedlings, respectively; and

FIGS. 13(a) and 13(b) are the diagrams showing the humidity curve at the center of the packaging carton box of the control group (CK) and the experiment group (Trt. 2) beneath and above the leaves of the Phalaenopsis seedlings, respectively.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

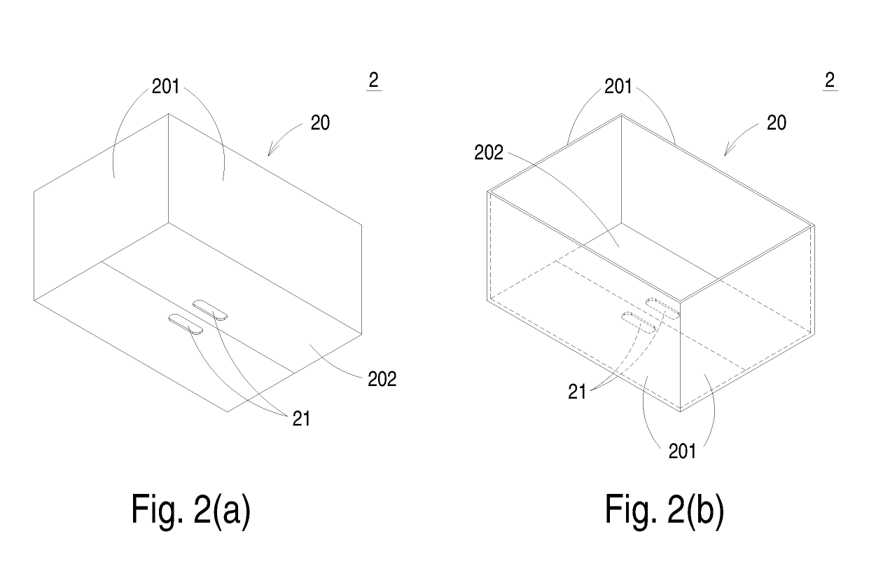

Please refer to FIGS. 2 (a) and 2(b), which are schematic diagrams showing the upward and vertical views of packaging carton box of the first embodiment of the present invention, respectively. As shown in FIGS. 2(a) and 2 (b), the main body 20 of packaging carton box 2 for flower and plant transportation has plural laterals 201 and a bottom surface 202. In this embodiment, the packaging carton box 2 is a rectangular cubic with four laterals 201, but not limited thereto. In other words, the shape of the packaging carton box 2 can be designed as tetrahedron or any other shape depending on the storage and shipping requirements. The bottom surface 202 of main body 20 comprises at least a pore hole 21. The pore hole 21 can be an oval-shaped pore hole 21. Of course, depending on the types of flower or plant stored within the main body 20 of packaging carton box 2, the pore hole 21 can be designed into different shape, such as rectangular or circular. The number of the pore hole 21 can also be one or plural.

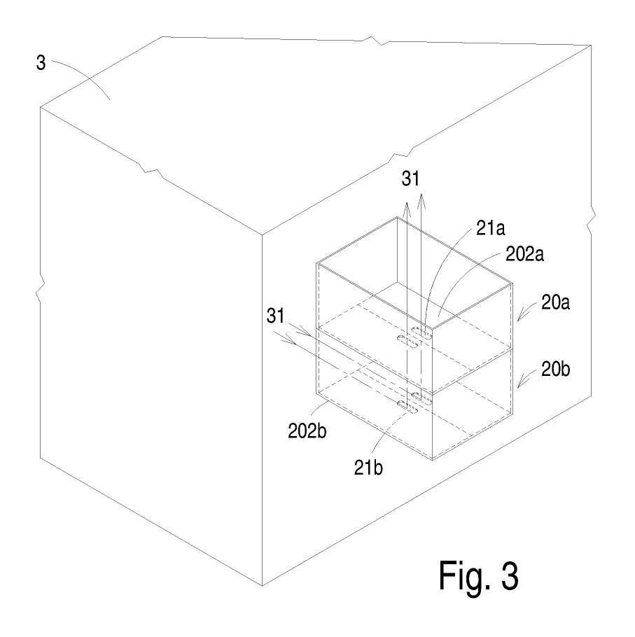

Please refer to FIG. 3, which is a schematic diagram showing a pile of the packaging carton boxes of FIG. 2 stored within a container. As shown in FIG. 3, the packaging carton boxes 2 are stacked and stored within a transport carrier during storage and shipment. The transport carrier can be a temperature-controlled refrigerated container 3 having a cold air flow 31 blowing from the bottom to top. Therefore, in this embodiment, when the main bodies 20a and 20b of packaging carton box 2 are stacked and stored in a refrigerated container 3, the cold air flow 31 of refrigerated container 3 blowing through the bottom surface 202b of the main body 20b at lower layer may enter the interior of the main body 20b via the pore hole 21b at the bottom surface 202b, and further flows into the interior of main body 20a via the pore hole 21a at the bottom surface 202a (as shown by the direction of arrow). In other words, when plural packaging carton boxes 2 are piled up, an air flow channel is formed by the pore holes 21a/21b at the bottom surfaces 202a/202b of the main bodies 20a/20b and thus allows the cold air flow 31 of refrigerated container 3 to enter the interior of each main body 20, so as to manipulate the interior temperature and humidity of the main body 20 of the packaging carton box 2.

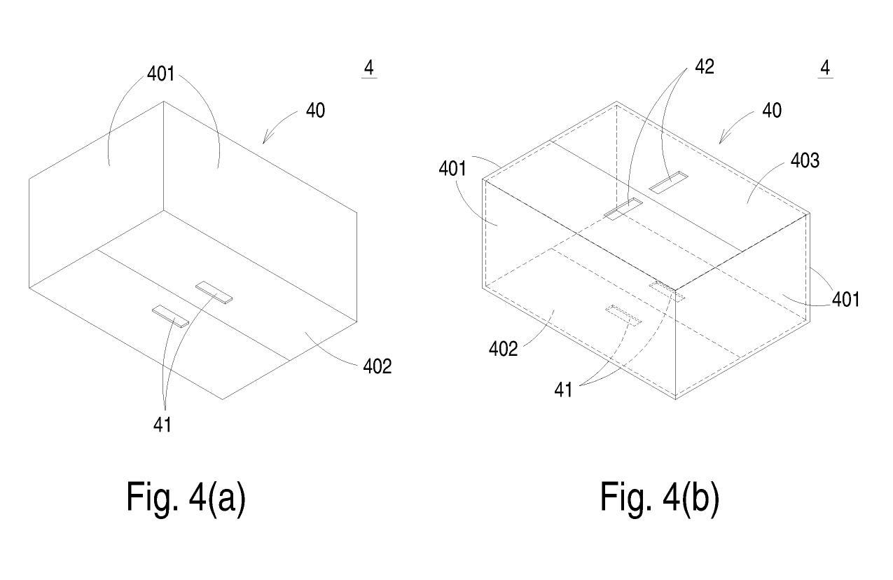

Obviously, for carrying different kinds of flowers or plants, the shape and structure of packaging carton box may be varied. Please refer to FIGS. 4(a) and 4(b), which are schematic diagrams showing the upward and vertical views of packaging carton box of the second embodiment of the present invention, respectively. As shown in FIGS. 4(a) and 4(b), the main body 40 of the packaging carton box 4 also comprises plural laterals 401 and a bottom surface 402. In addition, the packaging carton box 4 further has a cover 403 for covering the top of the main body 40.

Please refer to FIGS. 4(a) and 4(b) again, the bottom surface 402 of the main body 40 of the packaging carton box 4 comprises at least a first pore hole 41. The cover 403 comprises at least a second pore hole 42. In this embodiment, the first pore hole 41 and the second pore hole 42 are substantially rectangle pore holes. In other words, the shape of the first pore hole 41 and the shape of the second pore hole 42 can be the same. The locations of the first pore hole 41 and the second pore hole 42 are corresponded to each other. That is to say, the geometric centers of the first pore hole 41 and the second pore hole 42 are disposed on a same axis. Besides, the longitudinal directions of the first pore hole 41 and the second pore hole 42 are not parallel to each other; in other words, the first pore hole 41 and the second pore hole 42 are interlaced to one another.

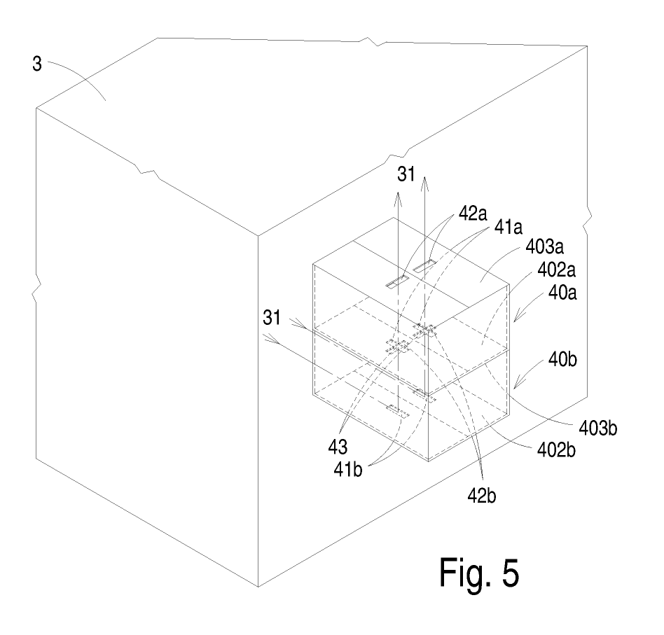

Please refer to FIG. 5, which is a schematic diagram showing a pile of the packaging carton boxes of FIG. 4 stored within a container. As shown in FIG. 5, when plural packaging carton boxes 4 are piled on top of each other, the bottom surface 402a of the upper main body 40a and the cover 403b of lower main body 40b are compactly contacted against each other. In this embodiment, the location of the first pore hole 41 at the bottom surface 402 is corresponded to that of the second pore hole 42 at the cover 403 of each main body 40, and the first and second pore holes 41/42 are interlaced arranged; thus the first pore hole 41a at the bottom surface 402a of the main body 40a at upper layer and the second pore hole 42b at the cover 403b of the main body 40b at lower layer under the main body 40a are crisscross arranged as a cross shape or an X shape as shown in FIG. 5. Hence the air flow channel 43 can be reserved at the joint of the first pore hole 41a of the main body 40a at upper layer and the second pore hole 42b of the main body 40b at lower layer even the piled main bodies 40a, 40b of the packaging carton boxes 4 are slightly shifted, so as to cooperate with the cold air flow 31 blowing from the bottom to the top of the refrigerated container 3. Accordingly, the cold air flow 31 may enter the interior of the main body 40b at lower layer via the first pore hole 41b and further enter the interior of the main body 40a through the air flow channel 43 and then flow to the exterior of the main body 40a from the second pore hole 42a (as shown by the direction of arrow). Hence the interior temperature and humidity of the packaging carton box 4 can be adjusted by the cold air flow 31. Moreover, since the second and first pore holes 42/41 at the cover 403 and the bottom surface 402 are corresponded and crisscross arranged, the flowing obstruction of the cold air flow 31 owing to the blockage of the first or second pore holes caused by the displacement of packaging carton boxes during shipment can be avoided effectively.

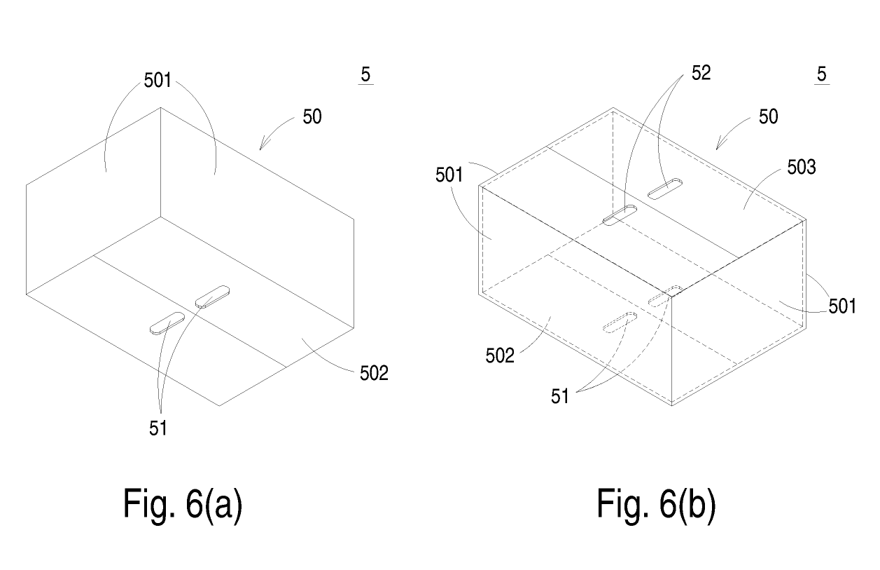

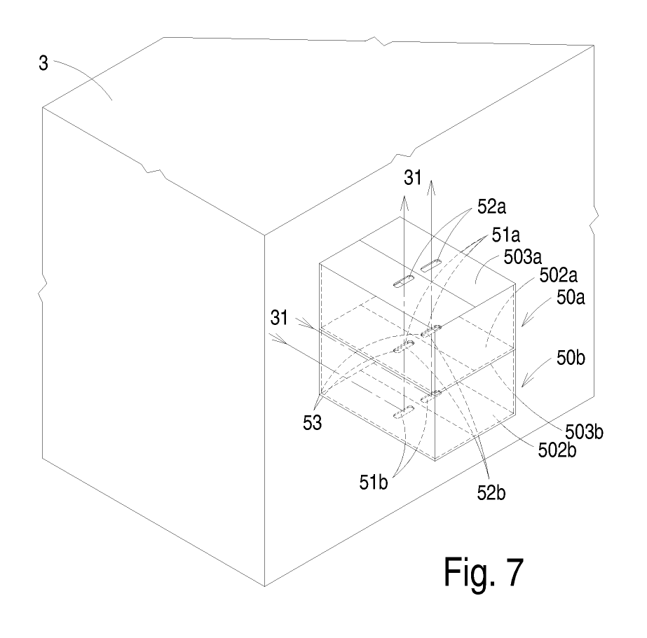

The shape and arrangement of the first and second pore holes are not limited to the foregoing embodiments. Please refer to FIG. 6(a) and cooperate with FIG. 6(b), which are schematic diagrams showing the upward and vertical views of packaging carton box of the third embodiment of the present invention, respectively. As shown in FIGS. 6(a) and 6(b), the main body 50 of the packaging carton box 5 and the laterals 501, the bottom surface 502, and the cover 503 thereof are the same as that shown in FIG. 4; thus it is not redundantly described here. The bottom surface 502 and the cover 503 also have a first pore hole 51 and a second pore hole 52, respectively. In this embodiment, the shape of the first pore hole 51 and the shape of the second pore hole 52 can be the same, such as being oval-shaped pore holes. However, not only the locations of the first pore hole 51 and the second pore hole 52 are corresponded to each other, the first pore hole 51 and the second pore hole 52 but also aligned and overlapped. While plural packaging carton boxes 5 are piled up and the relative position thereof are substantially fixed (as shown in FIG. 7), the cold air flow 31 of the refrigerated container 3 may enter the interior of the main body 50b at lower layer via the first pore hole 51b at the bottom surface 502b thereof and further enter the interior of the main body 50a through the air flow channel 53 formed by the overlapped second pore hole 52b of the main body 50b and first pore hole 51a of the main body 50a. Finally, the cold air flow 31 may blow out of the main body 50a from the second pore hole 52a at the cover 503a (as shown by the direction of arrow in FIG. 7). Thus the interior temperature and humidity of the main bodies 50a/50b can be effectively manipulated by the cold air flow 31 flowing therethrough.

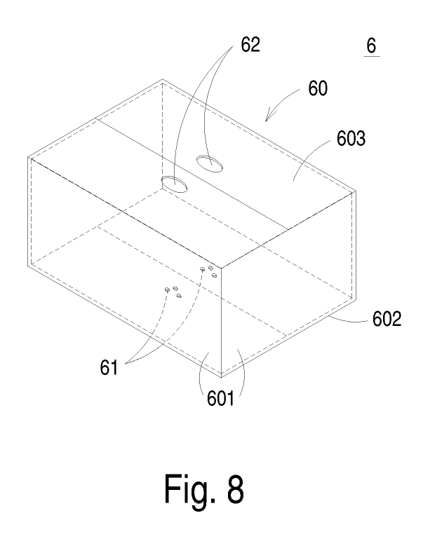

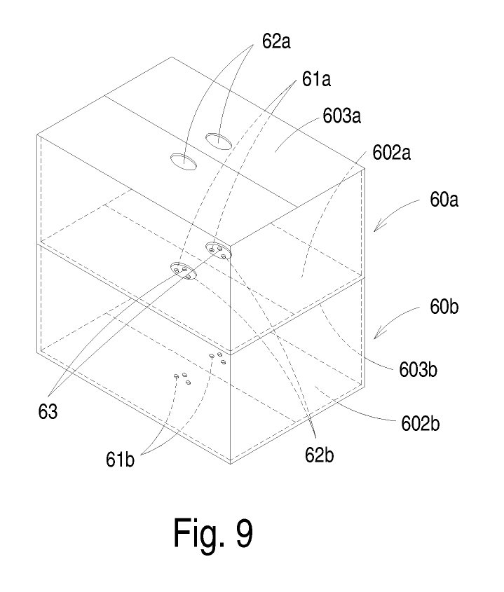

Of course, a plurality of first pore holes 61 corresponded to the second pore hole 62 of the cover 603 can be disposed at the bottom surface 602 of the packaging carton box 6 (as shown in FIG. 8). In this embodiment, the main body 60, the laterals 601, the bottom surface 602, and the cover 603 are similar to that of FIG. 4, except the first pore hole 61 and the second pore hole 62 are circular, and the area of the second pore hole 62 is larger than that of the first pore hole 61. Therefore, while the main bodies 60a/60b of the packaging carton boxes 6 are piled up, the first pore holes 61a with smaller areas at the bottom surface 602a of the main body 60a at upper layer are inclosed within the boundary of the second pore hole 62b with relative larger area at the cover 603b of the main body 60b at lower layer (as shown in FIG. 9), so as to form the air flow channel 63 at where the first pore hole 61a and the second pore hole 62b overlapped. The cold air flow (not shown) can enter the interior of the main body 60b through the first pore holes 61b, flow to the interior of the main body 60a via the air flow channel 63, and then flow out of the main body 60a via the second pore hole 62a. It is to be understood that the shape and size of the first and second pore holes are not limited to this embodiment. In other words, the first pore hole can be relative larger than the second pore hole (not shown), which means the area of the first pore hole is larger than that of the second pore hole. Besides, the shape of the pore holes can be circular, rectangular, oval-shaped or other geometric shapes, wherein the air circulation effect is not affected thereby. Thus the second pore hole is inclosed within the boundary of the first pore hole for the cold air flow to enter the interior of each main box through the air flow channel where the first and second pore holes overlapped.

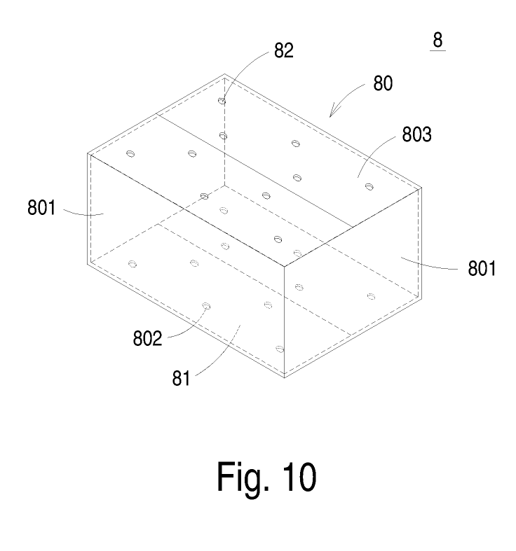

Please refer to FIG. 10, which is a schematic diagram showing the upward view of the packaging carton box of the fifth embodiment of the present invention. As shown in FIG. 10, the main body 80 of the packaging carton box 8 and the laterals 801, the bottom surface 802, and the cover 803 thereof are the same as that shown FIG. 4, except that the bottom surface 802 and the cover 803 have plural circular first pore holes 81 and plural circular second pore holes 82, respectively. In this embodiment, the bottom surface 802 and the cover 803 have plural pore holes 81/82 with the same shape. Therefore, it is to be understood that the cold air flow of the refrigerated container may flow into the interior of the main body 80 through the plural overlapped first and second pore holes 81/82 for manipulating the temperature and humidity therein.

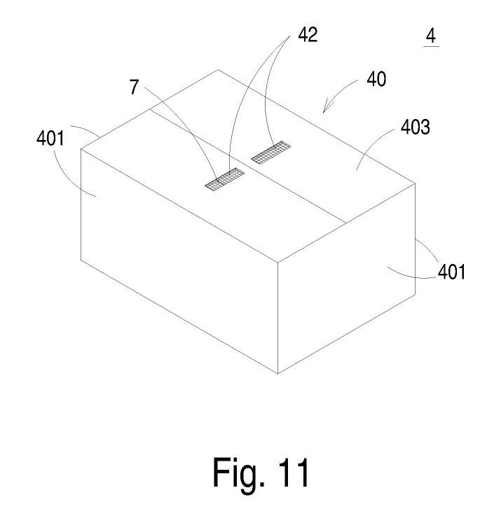

In addition, to satisfy with the import requirements of different countries, the packaging carton box 4 can further comprise an overlay 7 (as shown in FIG. 11) for covering the first and second pore holes 41, 42 of the main body 40. The overlay 7 is disposed in the main body 40 and composed of a net having fine pores or non-woven fabrics, but not limited thereto, so as to prevent the insects from getting into the main body. Since the overlay 7 comprises plural fine pores, the air circulation is not affected by the overlay 7. Of course, the overlay 7 can be disposed inside of the main body 40 as shown in FIG. 10 or outside of the main body. While the pile of main bodies 40 are stacked on the pallet (not shown), the overlay 7 can be disposed at the exterior of the pallet, so as to simplify the packaging procedure and lower the cost.

According to the foregoing description, it is to be understood that the shape of the pore hole is not limited, wherein the pore hole can be oval-shaped (as shown in FIG. 2), rectangular (as shown in FIG. 4) or other shape with different length and width. The pore hole can be circle (as shown in FIGS. 8 and 10), square or other polygon as well. In other words, the air circulation of the main body of the packaging carton box is not affected by the shape of the pore hole.

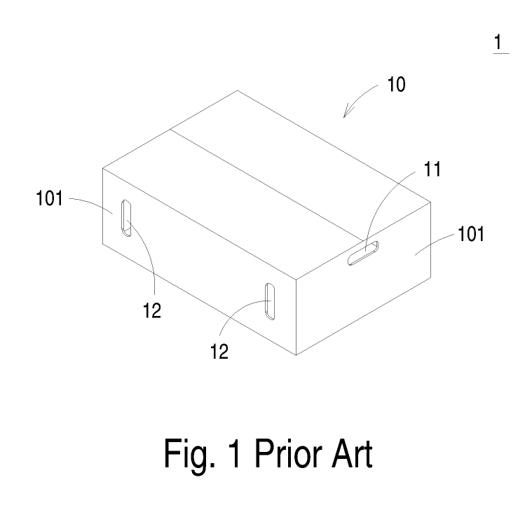

Furthermore, the number of the pore hole is not limited. That is to say, the number of the pore hole can be adjusted with the prerequisite of maintaining the structural strength of the main body of the packaging carton box. Since the pore hole is disposed at the bottom surface or at the bottom surface and the cover of the main body, the effect to the structural strength of the packaging carton box caused by the pore hole is relatively lower than the conventional packaging carton box with pore hole disposed at laterals as shown in FIG. 1. Therefore, the deficiency of structural damage cause by increasing the number of pore holes of the conventional packaging carton box can be avoided. Nevertheless, the structural intensity of the packaging carton box should be taken into consideration while manufacturing the packaging carton box.

Of course, the arrangement of the pore hole is not limited as well. When the main body of the packaging carton box is without the cover (as shown in FIG. 3), the pore hole can be disposed at any place at the bottom surface. Since the top of the main body is not sheltered by the cover, the cold air flow can enter the interior of each main body of the pile of packaging carton boxes via the pore hole at the bottom surface thereof, so as to control the temperature and humidity. When the main body of the packaging carton box further comprises a cover, the first pore hole at the bottom surface and the second pore hole at the cover can be crisscross arranged (as shown in FIG. 5), aligned and overlapped (as shown in FIG. 7) or designed with different size (as shown in FIG. 9), so as to form an air flow channel at the joint of the first pore hole and the second pore hole for the cold air flow to flow therethrough and enter the interior of each packaging carton box. Of course, the bottom surface and the cover may comprise a plurality of first pore holes and second pore holes, respectively, wherein the air flow may flow into the interior of the packaging carton box through the plural overlapped pore holes. In addition, the blockage of air flow channel cause by the displacement of the main body of packaging carton boxes during transportation can be further avoided owing to the design of the crisscross, different-size, or a plurality of the first and second pore holes for improving the air circulation while shipping.

The improvements of air circulation of the packaging carton box of the present invention in comparison with the air circulation of the conventional packaging carton box are illustrated by the following experiments.

### EXAMPLES

Phalaenopsis amabilis (moth orchid) plastic-bag seedlings were disposed in the common packaging carton box for export (72×51×34 cm³) by standard packaging method (40 Phalaenopsis seedlings vertically disposed in the main body of the packaging carton box) as control group (CK). The experiment factors of the experiment group (Trt. 2) were the same as those of control group except the pore holes were disposed at the bottom surface and the cover of the common packaging carton box (72×51×34 cm³). To simulate the export shipping condition, the packaging carton boxes of the control group and the experiment group were disposed in the refrigerator, wherein the temperature and the relative humidity of the refrigerator were controlled at 18° C. and 80-85%, respectively. In addition, two humidity-temperature meters (HOBO data logger, USA) were respectively disposed at the center of the packaging carton box beneath and above the leaves of the Phalaenopsis seedlings. The interior temperature and humidity of the packaging carton boxes were recorded every 10 minutes to determine the interior temperature and humidity variation during storage and shipping.

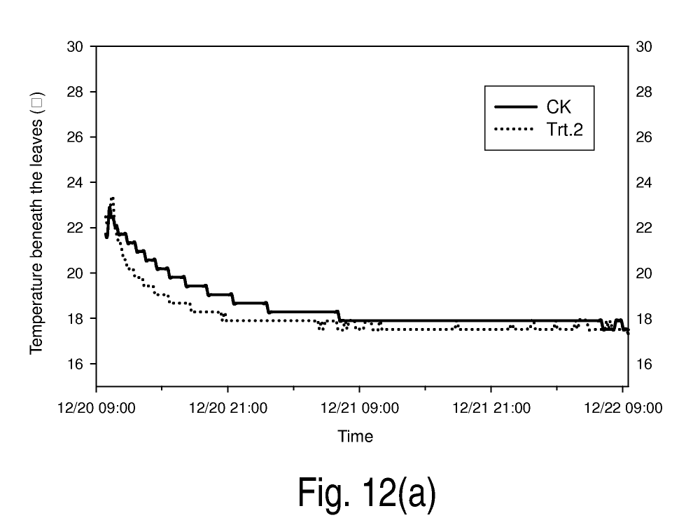

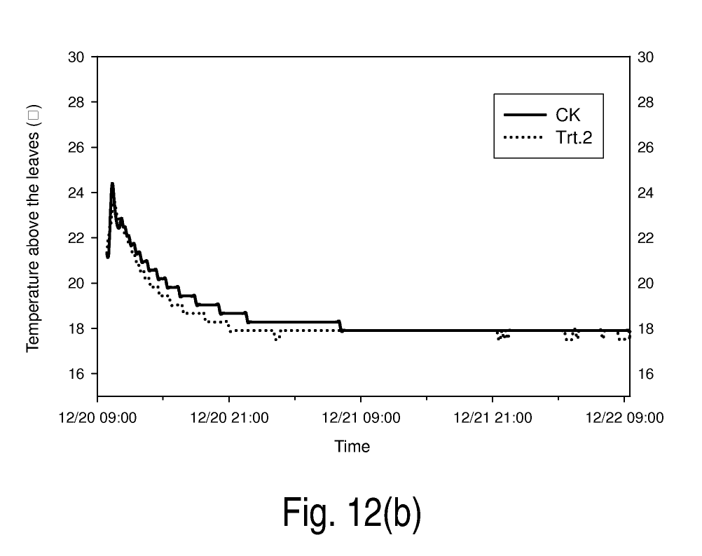

According to some export records, it is known that the deterioration rate of moth orchid elevates 5-20% per 2° C. increase in storage temperature. Therefore, it is important to rapidly control the interior temperature of the packaging carton box. Please refer to FIGS. 12(a) and 12(b), which are the diagrams showing the temperature curve at the center of the packaging carton box of the control group (CK) and the experiment group (Trt. 2) beneath and above the leaves of the Phalaenopsis seedlings, respectively. As shown in FIGS. 12(a) and 12(b), in the experiment group (Trt. 2), both of the temperature recorded beneath (FIG. 12(a)) and above (FIG. 12(b)) the leaves of the Phalaenopsis seedlings were lowered to approximately 18° C. after 12 hours, wherein the temperature was the same as that of the refrigerator. Unlike the control group (CK), the temperature was lowered to 18° C. after 24 hours.

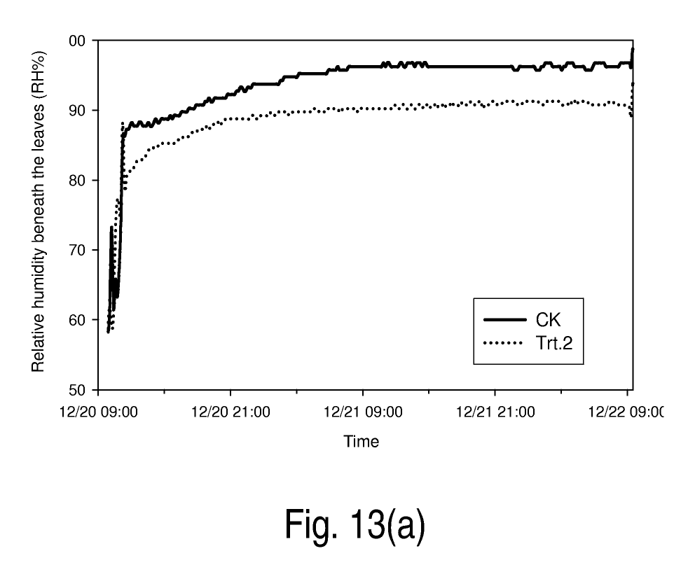

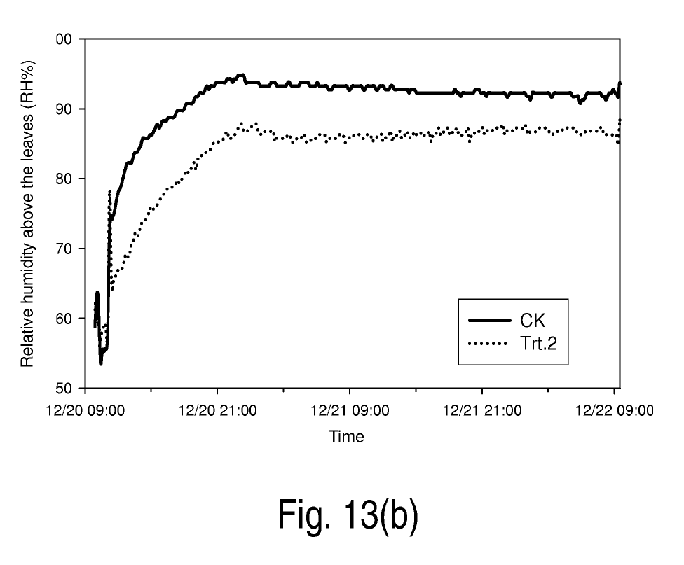

Similarly, the surroundings with high relative humidity may cause the rottenness of the moth orchid. FIGS. 13(a) and 13(b) show the humidity curve at the center of the packaging carton box of the control group (CK) and the experiment group (Trt. 2) beneath and above the leaves of the Phalaenopsis seedlings, respectively. As shown in FIGS. 13(a) and 13(b), the humidity of the control group (CK) raised above 90% within 12 hours when the packaging carton box was stored in the refrigerator. Besides, with the increase of storage time, the humidity of the control group (CK) raised to 95%. While in the experiment group (Trt. 2), the humidity recorded at the center of the packaging carton box beneath the leaves of the seedling was controlled at about 90% after storage for 48 hours (as shown in FIG. 13(a)), and the humidity recorded above the leaves of the seedling (as shown in FIG. 13(b)) can be further controlled at 85%, which was substantially similar to that of the refrigerator.

According to the foregoing experiments, it is to be understood that the design of pore holes at the bottom surface and the cover of the packaging carton box are beneficial for the cold air flow of the refrigerator to enter the interior of the packaging carton box for controlling the interior temperature and humidity thereof. Hence the purpose for decreasing the damage of the moth orchid during storage and shipment can be achieved.

To sum up, the packaging carton boxes with at least a pore hole disposed at the bottom surface or at both of the bottom surface and the cover are provided in the present invention, so as to cooperate with the cold air flow blowing from the bottom to the top of the refrigerated container. Hence the cold air flow can enter the interior of the packaging carton box via the pore hole at the bottom surface thereof. Comparing with the conventional packaging carton box, the air circulation effect is highly improved and the interior temperature and humidity of the packaging carton box are both well controlled, so as to avoid the rottenness and damage of flowers or plants during storage and shipping.

Besides, while the packaging carton box has cover and being piled up, the crisscross arranged, aligned and overlapped, different-sized, or plural first pore holes at the bottom surface and second pore holes at the cover can further be applied to form the air flow channel at the joint of the first and second pore holes. Thus the cold air flow can enter the interior of the packaging carton box at lower layer via the first pore holes and then enter the interior of the packaging carton box at upper layer via the air flow channel. Accordingly, the variation of the temperature and humidity while plural packaging carton boxes are piled up can be avoided. Meanwhile, the blockage of the air flow channel caused by the slightly displacement of packaging carton boxes can be further prevented by the foregoing design. Since the air circulation among plural of the packaging carton boxes are effectively improved, and the damage to the flowers and plants during storage and shipping is prevented by the present invention, the export quality can be improved as well.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A flower and plant packaging carton box for cooperating with a transport carrier with a cold air flow blowing from bottom to top, said packaging carton box comprising:
a main body, said main body having a bottom surface with at least a first pore hole, so as to form an air flow channel by said first pore hole of said main body for said cold air flow to enter the interior of each of said main body while piling plural of said packaging carton boxes.

2. The flower and plant packaging carton box according to claim 1 wherein the shape of said first pore hole is selected from the group consisting of rectangular, circle and oval-shape.

3. The flower and plant packaging carton box according to claim 1 wherein said packaging carton box further comprises a cover covering the top of said main body, and said cover comprises at least a second pore hole.

4. The flower and plant packaging carton box according to claim 3 wherein said first pore hole is corresponded to said second pore hole.

5. The flower and plant packaging carton box according to claim 4 wherein said first pore hole and said second pore hole are crisscross arranged, so as to form said air flow channel at the joint of said first pore hole and said second pore hole while plural of said packaging carton boxes are piled up.

6. The flower and plant packaging carton box according to claim 4 wherein said first pore hole and said second pore hole are aligned and overlapped, so as to form said air flow channel while plural of said packaging carton boxes are piled up.

7. The flower and plant packaging carton box according to claim 4 wherein said second pore hole is relatively larger than said first pore hole, so as to form said air flow channel at where said first pore hole and said second pore hole overlapped while plural of said packaging carton boxes are piled up.

8. The flower and plant packaging carton box according to claim 4 wherein said first pore hole is relatively larger than said second pore hole so as to form said air flow channel at where said first pore hole and said second pore hole overlapped while plural of said packaging carton boxes are piled up.

9. The flower and plant packaging carton box according to claim 3 wherein said bottom surface comprises a plurality of first pore holes and said cover comprises a plurality of second pore holes so as to form said air flow channel at where said first pore hole and said second pore hole overlapped while plural of said packaging carton boxes are piled up.

10. The flower and plant packaging carton box according to claim 1 further comprising an overlay for covering said packaging carton box or said first pore hole.
